(19) United States
(12) Patent Application Publication
(10) Pub. No.: US 2022/0291956 A1
(43) Pub. Date: Sep. 15, 2022

(54) DISTRIBUTED CONTAINER SCHEDULING METHOD AND SYSTEM BASED ON SHARED GPUS

(71) Applicant: Nanjing University of Posts and Telecommunications, Nanjing (CN)

(72) Inventors: Dengyin ZHANG, Nanjing (CN); Junjiang LI, Nanjing (CN); Zijie LIU, Nanjing (CN); Yi CHENG, Nanjing (CN); Yingjie KOU, Nanjing (CN); Hong ZHU, Nanjing (CN); Weidan YAN, Nanjing (CN)

(21) Appl. No.: 17/701,637

(22) Filed: Mar. 22, 2022

Related U.S. Application Data
(63) Continuation-in-part of application No. PCT/CN2021/138799, filed on Dec. 16, 2021.

(30) Foreign Application Priority Data
Mar. 11, 2021 (CN) 202110264399.4

(51) Int. Cl. G06F 9/48; G06F 9/54; H04L 9/40

(52) U.S. Cl. CPC G06F 9/4881; G06F 9/547; H04L 63/166

(57) ABSTRACT

A distributed container scheduling method includes: monitoring a container creation event in a Kubernetes API-Server in real time, and validating a container created once a new container creation event is detected; updating a container scheduling queue with containers passing the validation; when the container scheduling queue is empty, performing no operation until the containers passing the validation are added to the queue; when the container scheduling queue is not empty, reading the containers to be scheduled from the container scheduling queue in sequence, and selecting, from a Kubernetes cluster, an optimal node corresponding to the containers to be scheduled to generate a container scheduling two-tuple; and scheduling, based on the container scheduling two-tuple, the containers to be scheduled to the optimal node to finish the distributed container scheduling operation.

### CROSS-REFERENCE TO RELAYED APPLICATIONS

This application is a continuation-in-part of International Patent Application No. PCT/CN2021/138799 with an international filing date of Dec. 16, 2021, designating the United States, now pending, and further claims foreign priority benefits to Chinese Patent Application No. 202110264399.4 filed Mar. 11, 2021. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of cloud computing, and more particularly to a distributed container scheduling method and system based on shared graphics processing units (GPUs).

With the development of cloud computing, the resource utilization in a server cluster can be improved by Kubernetes (an application managing container in a plurality of hosts in a cloud platform). However, with the increasing diversification and complexity of cloud computing services, using containers with graphics processing units (GPUs) to enhance the performance and efficiency of services and workflows has become the computing mainstay integrating edge computing and large distributed machine learning. Moreover, existing distributed container schedulers mostly can only schedule container tasks based on a Central Processing Unit (CPU) and memory metrics, or can only simply detect the number of GPUs rather than the performance metrics of graphics card chips to share the GPUs. The existing distributed container schedulers are incapable of adapting to the computing requirements of various complex scenarios, resulting in scheduling the containers with specific GPU requirements to run at non-adaptive nodes, which makes the GPU resources of the entire distributed cluster underutilized and affects the performance of the entire distributed cluster.

In the field of cloud computing, the services and workflows applying GPUs are gradually diversified, such as cloud games and machine learning and training, which will bring more challenges to the scheduling of GPU resources. The containers in a distributed cluster need to be scheduled reasonably based on the current state of GPU metrics in the cluster. Otherwise, tasks in the distributed cluster are imbalanced, which affects the scheduling result of GPU resources and indirectly reduces the computing efficiency of the distributed cluster.

### SUMMARY

To solve the problems of unreasonable container scheduling and low utilization of GPU resources in diversified cloud computing services, the disclosure provides a distributed container scheduling method and system based on shared GPUs, which can monitor a container creation event, generate a container scheduling queue and schedule containers. In the disclosure, the most adaptive node can be selected for container scheduling based on the requirements of a container to be scheduled, so as to ensure the load balance of nodes in a cluster and improve the resource utilization of the cluster.

According to the disclosure, a distributed container scheduling method based on shared GPUs is proposed, comprising following steps of:

monitoring a container creation event in a Kubernetes API-Server in real time, and validating a container created once a new container creation event is detected;

updating a container scheduling queue with containers passing the validation;

when the container scheduling queue is empty, performing no operation until the containers passing the validation are added to the queue; when the container scheduling queue is not empty, reading the containers to be scheduled from the container scheduling queue in sequence, and selecting, from a Kubernetes cluster, an optimal node corresponding to the containers to be scheduled to generate a container scheduling two-tuple; and

scheduling, based on the container scheduling two-tuple, the containers to be scheduled to the optimal node to finish the distributed container scheduling operation.

In a class of this embodiment, validating the container created comprise:

validating GPU tags based on field information of the container created: determining whether the container created carries the GPU tags or not; if not, indicating that the GPU tag validation fails, writing the validation failure time and corresponding error information into a Kubernetes event log; and if so, indicating that the GPU tag validation is passed, where the GPU tags comprise a GPU quantity tag, a GPU memory tag and a GPU clock frequency tag; and

validating a scheduler name based on the field information of the container created when the GPU tag validation is passed: determining whether a scheduler field of the container is the scheduler name of a system or not; if not, indicating that the validation of the scheduler name fails, writing the validation failure time and corresponding error information into the Kubernetes event log; and if so, indicating that the validation of the scheduler name is passed and the container validation is finished.

In a class of this embodiment, updating a container scheduling queue with containers passing the validation comprise:

sending the containers passing the validation to the container scheduling queue from a rear of the queue; and

acquiring a default priority tag of each container in the container scheduling queue, and sorting all the containers in the container scheduling queue in a descending order based on the priority tags to finish updating the container scheduling queue.

In a class of this embodiment, selecting an optimal node corresponding to the containers to be scheduled from a Kubernetes cluster comprise:

selecting and filtering nodes in the Kubernetes cluster based on GPU data of each node and the GPU tags of the containers to be scheduled to obtain container schedulable nodes;

when there is one container schedulable node, taking this container schedulable node as the optimal node; and

when there is more than one container schedulable node, calculating a score of each container schedulable node based on the GPU data of the container schedulable node, and selecting the container schedulable node with the highest score as the optimal node.

In a class of this embodiment, the container schedulable nodes are acquired by following operations:

traversing all nodes in the Kubernetes cluster when the container to be scheduled carries the GPU quantity tag, marking a node as a primary schedulable node when the number of GPUs at the node is greater than or equal to the value of the GPU quantity tag, marking all the nodes in the Kubernetes cluster as primary schedulable nodes when the container to be scheduled does not carry the GPU quantity tag, and setting the value of the GPU quantity tag of the container to be scheduled to 1;

traversing all the primary schedulable nodes when the container to be scheduled carries the GPU memory tag; taking the GPUs at the primary schedulable nodes as the GPUs meeting first level requirements when free memory of the GPUs is greater than the value of the GPU memory tag of the container to be scheduled; marking the primary schedulable nodes as secondary schedulable nodes when the number of GPUs meeting the first level requirements is greater than or equal to the value of the GPU quantity tag of the container to be scheduled, and marking all the primary schedulable nodes as secondary schedulable nodes when the container to be scheduled does not carry the GPU memory tag;

traversing all the secondary schedulable nodes when the container to be scheduled carries the GPU clock frequency tag; taking the GPUs at the secondary schedulable nodes as the GPUs meeting second level requirements when the clock frequency of the GPUs is greater than the value of the GPU clock frequency tag; marking the secondary schedulable nodes as the container schedulable nodes when the number of GPUs meeting the second level requirements is greater than or equal to the value of the GPU quantity tag of the container to be scheduled; and marking all the secondary schedulable nodes as the container schedulable nodes when the container to be scheduled does not carry the GPU clock frequency tag; and

writing the current time and scheduling error information into the Kubernetes event log when the container schedulable node is null.

In a class of this embodiment, a calculation formula of the score of each container schedulable node based on the GPU data of the container schedulable node is as follows:

Score=FilteredGPUScore×FilteredGPUWeight+RealScore×RealWeight+AllocateScore×AllocateWeight (1)

where Score represents the score of the container schedulable node, FilteredGPUScore represents a GPU score of all the GPUs meeting the requirements of the container to be scheduled at the specific container schedulable node, and the requirements of the container to be scheduled are the GPU memory tag and the GPU clock frequency tag of the container to be scheduled, FilteredGPUWeight is the weight of the GPU score, RealScore represents a memory score of all the GPUs at the specific container schedulable node, RealWeightis the weight of the memory score, AllocateScore represents an allocated score of the container schedulable node, and AllocateWeight is the weight of the allocated score;

calculation formulas of FilteredGPUScore are as follows:

$$FilteredGPUScore = \sum FilteredGPUScorePerCard \qquad ( 2 )$$

$$FilteredGPUScorePerCard = \frac{Bandwith}{MaxBandwith} \times 100 + \frac{Clock}{MaxClock} \times 100 + \frac{Power}{MaxPower} \times 100 + \frac{Core}{MaxCore} \times 100 + \frac{FreeMemory}{MaxFreeMemory} \times 100 + \frac{TotalMemory}{MaxTotalMemory} \times 100 \qquad ( 3 )$$

where FilteredGPUScorePerCard represents the GPU score of the GPUs meeting the requirements of the container to be scheduled at the specific container schedulable node, Bandwith represents the bit bandwidth of the GPU memory, MaxBandwith represents the maximum bit bandwidth of the GPU memory of all the GPUs meeting the requirements of the container to be scheduled at the specific container schedulable node, Clock represents the GPU clock frequency, MaxClock represents the maximum GPU clock frequency of all the GPUs meeting the requirements of the container to be scheduled at the specific container schedulable node, Power represents the GPU power, MaxPower represents the maximum GPU power of all the GPUs meeting the requirements of the container to be scheduled at the specific container schedulable node, Core represents the number of GPU cores, MaxCore represents the maximum number of GPU cores of all the GPUs meeting the requirements of the container to be scheduled at the specific container schedulable node, FreeMemoryrepresents the CPU free memory; MaxFreeMemory represents the maximum GPU free memory of all the GPUs meeting the requirements of the container to be scheduled at the specific container schedulable node, TotalMemory represents the total GPU memory, and MaxTotalMemory represents the maximum total GPU memory of all the GPUs meeting the requirements of the container to be scheduled at the specific container schedulable node;

a calculation formula of RealScore is as follows:

$$RealScore = \frac{FreeMemorySum \times 100}{TotalMemorySum} \qquad ( 4 )$$

where FreeMemorySum represents the sum of GPU free memory of all the GPUs at the specific container schedulable node, andTotalMemorySum represents the sum of the total GPU memory of all the GPUs at the specific container schedulable node;

a calculation formula of AllocateScore is as follows:

$$AllocateScore = \frac{( TotalMemorySum - AllocateMemorySum ) \times 100}{TotalMemorySum} \qquad ( 5 )$$

where AllocateMemorySum represents the total memory requested by the container to be scheduled, which is the product of the value of the GPU memory tag and the value of the GPU quantity tag value of the container to be scheduled.

In a class of this embodiment, the container scheduling two-tuple comprises the containers to be scheduled and a node name of the optimal node.

In a class of this embodiment, the containers to be scheduled are scheduled to the optimal node based on the container scheduling two-tuple by following operations:

configuring, based on the container scheduling two-tuple, a node name field of the containers to be scheduled as the node name of the optimal node in the two-tuple, and updating the node name field of the containers in the Kubernetes API-Server asynchronously.

The disclosure also provides a distributed container scheduling system based on shared GPUs, the system comprising:

a container creation event monitor configured to monitor a container creation event in a Kubernetes API-Server, and validate containers once a new container creation event is detected;

a container scheduling queue configured to store containers to be scheduled based on priorities;

a container scheduler configured to read containers to be scheduled from the front of the container scheduling queue, and select, from a Kubernetes cluster, an optimal node corresponding to the containers to be scheduled to generate a container scheduling two-tuple;

a container scheduling executor configured to update, based on the container scheduling two-tuple, a node name field of the containers to be scheduled in the Kubernetes API-Server to finish the container scheduling operation; and

a communication module configured to enable the container creation event monitor, the container scheduling queue, the container scheduler and the container scheduling executor to establish communications with the Kubernetes API-Server respectively based on system config files.

In a class of this embodiment, each system config file comprises an IP address, a port number, a TLS public key and a TLS private key of the Kubernetes API-Server;

the communication is established based on the system config files by following operations:

establishing communication links between the container creation event monitor, the container scheduling queue, the container scheduler, the container scheduling executor and the Kubernetes API-Server based on the IP address and the port number; and

authenticating the communication links according to the TLS public key and the TLS private key, and finishing the communication establishment after authentication is passed.

The following advantages can be achieved using the above technologies.

According to the disclosure, distributed container scheduling method and system based on shared GPUs are proposed. In the process of scheduling containers in the disclosure, the nodes are selected based on the requirements such as the number of GPUs, the CPU memory and the CPU clock frequency of the containers, and the containers are reasonably scheduled based on the fine granularity metric state of GPU graphics cards in the cluster, so that multiple container tasks may share the GPUs. In this way, the GPU resource utilization of the cluster can be improved to meet the computing requirements of complex scenarios by scheduling containers to the most adaptive node based on the metric state, free memory and allocation of the graphics cards at the node. Compared with the prior art, it is possible in the disclosure to ensure the load balance of nodes in the cluster, enhance the utilization of GPU resources in the distributed container cluster, better meet the scheduling requirements, and allow containers to complete tasks faster.

### BRIEF DESCRIPTION OF THE DRAWINGS

FIG. 1 is a flow chart of a distributed container scheduling method based on shared GPUs according to the disclosure;

FIG. 2 is a flow chart of updating a container scheduling queue according to the embodiment of the disclosure;

FIG. 3 is a flow chart of selecting and filtering nodes according to the embodiment of the disclosure;

FIG. 4 is a structural diagram of a distributed container scheduling system based on shared GPUs according to the disclosure;

FIG. 5 is a functional diagram of the distributed container scheduling system according to an embodiment of the disclosure;

FIG. 6 is a schematic diagram of changes in load balance entropy when different schedulers schedule containers according to the embodiment of the disclosure; and

FIG. 7 is a schematic diagram of changes in scheduling time when different schedulers schedule containers according to the embodiment of the disclosure;

In the drawings, the following reference numbers are used: 1. Container creation event monitor, 2. Container scheduling queue; 3. Container scheduler; 4. Container scheduling executor; and 5. Communication module.

### DETAILED DESCRIPTION

To further illustrate, embodiments detailing a distributed container scheduling method and system based on shared graphics processing units (GPUs) are described below. It should be noted that the following embodiments are intended to describe and not to limit the disclosure.

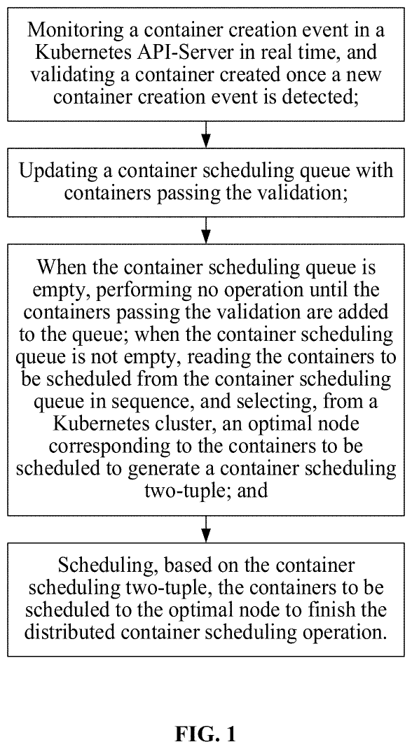

According to the disclosure, a distributed container scheduling method based on shared GPUs is proposed, as shown in FIG. 1, which comprises following steps.

In step A, the container creation event is monitored in a Kubernetes API-Server in real time, and containers created are validated once a new container creation event is detected.

In step B, a container scheduling queue is updated with the containers passing the validation.

In step C, when the container scheduling queue is empty, no operation is performed until the containers passing the validation are added to the queue; when the container scheduling queue is not empty, the containers to be scheduled are read from the container scheduling queue in sequence, and an optimal node corresponding to the containers to be scheduled is selected from a Kubernetes cluster to generate a container scheduling two-tuple.

In step D, the containers to be scheduled are scheduled to the optimal node based on the container scheduling two-tuple to finish the distributed container scheduling operation.

In step A, the communication is established with the Kubernetes API-Server through a network to monitor the container creation event in the Kubernetes API-Server in real time. Users of a system can create GPU containers by sending a request to the Kubernetes API-Server through kubectl to generate a container creation event. Before creation, the container's image name, container scheduling priority tag, container startup command, container startup parameters, and GPU tags for the container may be manually configured, where the GPU tags comprise a GPU quantity tag, a GPU memory tag and a GPU clock frequency tag. The Kubernetes API-Server can instantiate (create) container objects based on the container creation event and store the objects. When the new container creation event is detected, it is necessary to acquire field information of the container objects created by the container creation event, and validate the containers based on the field information.

The containers created are validated by following steps.

In step A01, the GPU tags are validated based on the field information of the containers created: whether the container created carries the GPU tags is determined. If the container does not carry any one of the GPU tags, the GPU tag validation fails, and the validation failure time and corresponding error information (excluding the GPU tags) are written into a Kubernetes event log for subsequent search of the error information. If the container carries one or more GPU tags, the GPU tag validation is passed, and subsequent operations may be performed.

In step A02, a scheduler name is validated based on the field information of the containers created when the GPU tag validation is passed: whether a scheduler field of the container is the scheduler name of a system is determined. If not, the validation of the scheduler name fails, and the validation failure time and corresponding error information (the scheduler field of the container) are written into the Kubernetes event log. If so, the validation of the scheduler name is passed, the container validation is finished and passed.

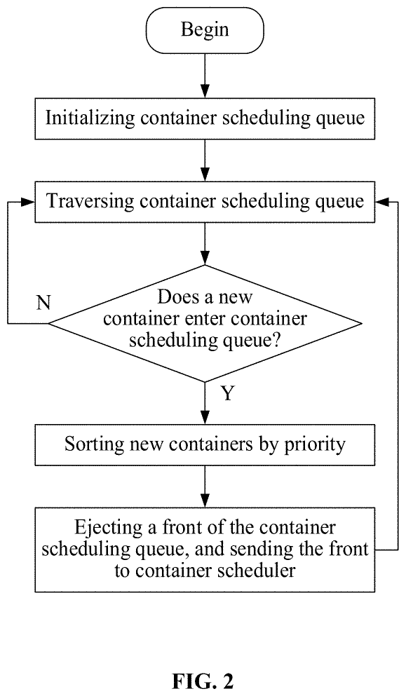

In step B, the containers passing the validation are sent to the container scheduling queue, and the container scheduling queue is updated. As shown in FIG. 2, the steps are as follows.

In step B01, the containers passing the validation are sent to the container scheduling queue from the rear of the queue to generate a container scheduling queue at the current moment.

In step B02, a default priority tag of each container in the container scheduling queue is acquired, and all the containers in the container scheduling queue are sorted in a descending order based on the priority tags, with the container at the highest priority ranked at the front of the container scheduling queue and the container with the lowest priority ranked at the rear of the queue, so as to finish updating the container scheduling queue.

In the embodiment of the disclosure, step C comprises following steps:

In step C01, the container scheduling queue is monitored in real time to see whether it is empty or not. If so, no operation is performed until the containers passing the validation are added to the queue; if not, one container to be scheduled is read from the front of the container scheduling queue, and the GPU tags of the container to be scheduled are acquired. Furthermore, in the disclosure, a request is sent to the Kubernetes API-Server to acquire GPU data of all nodes in the current Kubernetes cluster, such as the number of GPUs at the node, the memory bit bandwidth of each GPU at the node, the GPU clock frequency, the number of GPU cores, the total GPU memory, the total available GPU memory, and the GPU power.

In step C02, the nodes in the Kubernetes cluster are selected and filtered based on the GPU data of each node and the GPU tags of the container to be scheduled to obtain container schedulable nodes.

In step C03, when there is one container schedulable node, this container schedulable node serves as the optimal node.

In step C04, when there is more than one container schedulable node, a score of each container schedulable node is calculated based on the GPU data of the container schedulable node, and the container schedulable node with the highest score is selected as the optimal node.

In step C05, the containers to be scheduled and a node name of the optimal node are adopted to form the container scheduling two-tuple.

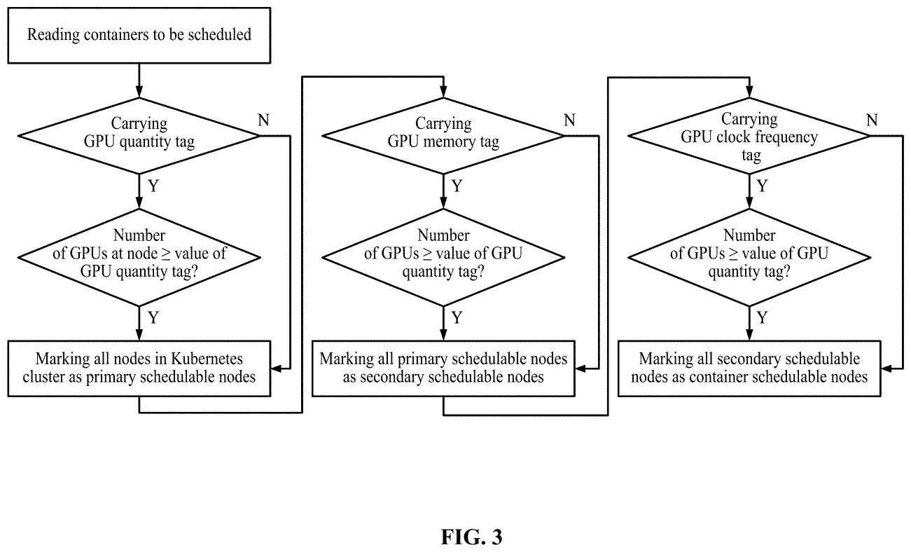

The container schedulable nodes are nodes meeting the requirements of the container to be scheduled in the Kubernetes cluster. As shown in FIG. 3, the container schedulable nodes are mainly filtered in three dimensions in the disclosure.

In step C021, the nodes are filtered based on the GPU quantity tag: all the nodes in the Kubernetes cluster are traversed when the container to be scheduled carries the GPU quantity tag; when the number of GPUs at a node is greater than or equal to the value of the GPU quantity tag, the node is marked as primary schedulable node; all the nodes in the Kubernetes cluster are marked as primary schedulable nodes when the container to be scheduled does not carry the GPU quantity tag, and the value of the GPU quantity tag of the container to be scheduled is set to 1.

In step C022, the nodes are filtered based on the GPU memory tag after step C021: all the primary schedulable nodes are traversed when the container to be scheduled carries the GPU memory tag; the GPUs at the primary schedulable nodes serve as the GPUs meeting first level requirements when the free memory of the GPUs is greater than the value of the GPU memory tag of the container to be scheduled; the primary schedulable nodes are marked as secondary schedulable nodes when the number of GPUs meeting the first level requirements is greater than or equal to the value (which is 1 in default when the container to be scheduled does not carry the GPU quantity tag in step C021) of the GPU quantity tag of the container to be scheduled; and all the primary schedulable nodes are marked as secondary schedulable nodes when the container to be scheduled does not carry the GPU memory tag.

In step C023, the nodes are filtered based on the GPU clock frequency tag after step C022: all the secondary schedulable nodes are traversed when the container to be scheduled carries the GPU clock frequency tag; the GPUs at the secondary schedulable nodes serve as GPUs meeting second level requirements when the clock frequency of the GPUs is greater than the value of the GPU clock frequency tag; the secondary schedulable nodes are marked as the container schedulable nodes when the number of GPUs meeting the second level requirements is greater than or equal to the value of the GPU quantity tag of the container to be scheduled; and all the secondary schedulable nodes are marked as the container schedulable nodes when the container to be scheduled does not carry the GPU clock frequency tag.

In step C024, the current time and scheduling error information (the container schedulable node is null) are written into the Kubernetes event log when the container schedulable node is null after being filtered in three dimensions.

In the embodiment of the disclosure, the score of the container schedulable nodes in step C04 mainly comprises three parts: 1, a score when the GPU meets the requirements of the container to be scheduled, and the requirements of the container to be scheduled are the GPU memory tag and the GPU clock frequency tag of the container to be scheduled; 2, a memory score of all the GPUs at the node; and 3, an allocated score of the node.

A calculation formula of the GPU score meeting the requirements of the container to be scheduled is as follows:

FilteredGPUScore=ΣFilteredGPUScorePerCard (2)

where FilteredGPUScore represents the GPU score of all the GPUs meeting the requirements of the container to be scheduled at the specific container schedulable node, and FilteredGPUScorePerCard represents the GPU score of one GPU meeting the requirements of the container to be scheduled at the container schedulable node.

A calculation formula of FilteredGPUScorePerCard is as follows:

$$FilteredGPUScorePerCard = \frac{Bandwith}{MaxBandwith} \times 100 + \frac{Clock}{MaxClock} \times 100 + \frac{Power}{MaxPower} \times 100 + \frac{Core}{MaxCore} \times 100 + \frac{FreeMemory}{MaxFreeMemory} \times 100 + \frac{TotalMemory}{MaxTotalMemory} \times 100 \qquad ( 3 )$$

where Bandwith represents the bit bandwidth of the GPU memory, MaxBandwith represents the maximum bit bandwidth of the GPU memory of all the GPUs meeting the requirements of the container to be scheduled at the specific container schedulable node, Clock represents the GPU clock frequency, MaxClock represents the maximum GPU clock frequency of all the GPUs meeting the requirements of the container to be scheduled at the specific container schedulable node, Power represents the GPU power, MaxPower represents the maximum GPU power of all the GPUs meeting the requirements of the container to be scheduled at the specific container schedulable node, Core represents the number of GPU cores, MaxCore represents the maximum number of GPU cores of all the GPUs meeting the requirements of the container to be scheduled at the specific container schedulable node, FreeMemory represents the CPU free memory, MaxFreeMemory represents the maximum GPU free memory of all the GPUs meeting the requirements of the container to be scheduled at the specific container schedulable node, TotalMemory represents the total GPU memory, and MaxTotalMemory represents the maximum total GPU memory of all the GPUs meeting the requirements of the container to be scheduled at the specific container schedulable node.

A calculation formula of the memory score of all the GPUs at the nodes is as follows:

$$RealScore = \frac{FreeMemorySum \times 100}{TotalMemorySum} \qquad ( 4 )$$

where RealScore represents the memory score of all the GPUs at the specific container schedulable node, FreeMemorySum represents the sum of the GPU free memory of all the GPUs at the specific container schedulable node, and TotalMemorySum represents the sum of the total GPU memory of all the GPUs at the specific container schedulable node.

A calculation formula of the allocated score of the node is as follows:

$$AllocateScore = \frac{( TotalMemorySum - AllocateMemorySum ) \times 100}{TotalMemorySum} \qquad ( 5 )$$

where AllocateScore represents the allocated score of the container schedulable node, and AllocateMemorySum represents the total memory requested by the container to be scheduled, which is the product of the value of the GPU memory tag and the value of the GPU quantity tag value of the container to be scheduled.

According to the formulas (2) to (5), a calculation formula of the Score of the container schedulable node is as follows:

Score=FilteredGPUScore×FilteredGPUWeight+RealScore×RealWeight+AllocateScore×AllocateWeight (1)

where FilteredGPUWeight is the weight of the GPU score with a default value of 2, RealWeight is the weight of the memory score with a default value of 1, and AllocateWeight is the weight of the allocated score with a default value of 2.

In the embodiment of the disclosure, step D comprises following steps of: configuring, based on the container scheduling two-tuple, a node name field of the container to be scheduled as the node name of the optimal node in the two-tuple, and updating the node name field of the containers in the Kubernetes API-Server asynchronously.

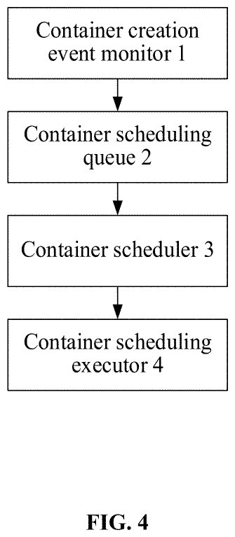

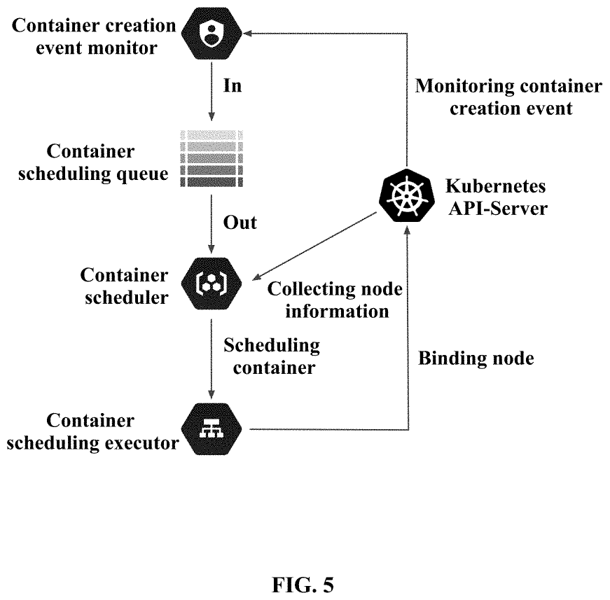

According to the disclosure, a distributed container scheduling system based on shared GPUs is further proposed. As shown in FIG. 4, the system mainly comprises a container creation event monitor 1, a container scheduling queue 2, a container scheduler 3, a container scheduling executor 4 and a communication module 5, and its operating principle in the disclosure is shown in FIG. 5.

The container creation event monitor is mainly configured to monitor a container creation event in a Kubernetes API-Server, validate containers once a new container creation event is detected, and further send the containers passing the validation to a container scheduling queue. Its operating process is the same as step A of the method in the disclosure. The container scheduling queue is mainly configured to store the containers to be scheduled based on priorities, and its operating process is the same as step B of the method in the disclosure. The container scheduler is configured to read the containers to be scheduled from the front of the container scheduling queue, and select, from a Kubernetes cluster, an optimal node corresponding to the containers to be scheduled to generate a container scheduling two-tuple, and its operating process is the same as step C of the method in the disclosure. The container scheduling executor is mainly configured to update, based on the container scheduling two-tuple, a node name field of the containers to be scheduled in the Kubernetes API-Server to finish the container scheduling operation to bind the node, and its operating process is the same as step D of the method in the disclosure.

The communication module is configured to help the container create event monitor, the container scheduling queue, the container scheduler and the container scheduling executor to establish communication links with the Kubernetes API-Server. The communication module acquires system config files comprising an IP address, a port number, a TLS public key and a TLS private key of the Kubernetes API-Server. The communication module first checks whether each system config file carries the IP address and the port number, and, if so, reads the IP address and the port number and tries to establish communication with the Kubernetes cluster based on the IP address and port number. If the communication is established, the container creation event monitor, the container scheduling queue, the container scheduler, the container scheduling executor establish a communication link with the Kubernetes API-Server. The communication module rechecks whether each system config file carries the TLS public key and the TLS private key, and, if so, tries to communicate with the Kubernetes API-Server through the TLS public key and the TLS private key to authenticate the communication link. If the authentication is passed, the communication is established to enable the container creation event monitor, the container scheduling queue, the container scheduler and the container scheduling executor to perform information interaction with the Kubernetes API-Server. If the system config file does not exist, the IP address is inaccessible, the port is closed or the authentication fails, the communication failure time and cause are recorded to generate failure information which is recorded locally and sent to operation and maintenance engineers by mail for inspection and repair.

To validate the container scheduling effect of the disclosure, following experiments are given in the embodiment of the disclosure.

According to the embodiment of the disclosure, a scheduling simulator named Node Simulator is adopted to simulate node resources and states of containers in the Kubernetes. The Node Simulator is configured on a physical server where a Kubernetes control plane is located as shown in Table 1.

TABLE 1

| | | Number of | Memory | Hard disk |
|---|---|---|---|---|
| Node type | CPU model | CPU cores | (GiB) | (GiB) |
| Kubernetes | Intel(R) Xeon(R) | 40 | 64 | 1998 |
| control | Silver 4114 | | | |
| plane | CPU 2.20 GHz * 4 | | | |

In the embodiment of the disclosure, the containers are all configured as machine learning tasks each requiring mainstream frameworks such as Tensorflow and Pytorch, and all containers are configured to consume GPU resources after 10s of operation. In experiments, the Kubernetes scheduler and the Kubeshare serve as the comparative references, and all experiments are repeated 20 times to calculate the average value to ensure the validity of the results. The Node Simulator generates 10

Kubernetes nodes each provided with four NVIDIA TITAN-Xp GPUs. The configuration parameters are shown in Table 2.

TABLE 2

| | Number | Number of | Memory | Hard disk | GPU |
|---|---|---|---|---|---|
| Node type | of nodes | CPU cores | (GiB) | (GiB) | model |
| TITAN-Xp | 10 | 20 | 512 | 4096 | NVIDIA |
| node | | | | | TITAN- |
| | | | | | XpGPU * 4 |

Experiment 1:

In the experiment 1, load balance entropy is selected to measure the load balance and defined as follows

$$E ( U ) = \frac{{\sum }_{i = 0}^{{N}_{- 1}} {u}_{i} log {u}_{i}}{log N} \qquad ( 6 )$$

where E(U) represents the load balance entropy, N represents the number of nodes in the cluster, and uᵢ represents the GPU memory utilization at an i^{th} node, i=0, 1, . . . , N−1.

$${u}_{i} = \frac{{\sum }_{j = 1}^{{n}_{i}} {pod}_{j} . gpu\_memory}{\sum pod . gpu\_memory} \qquad ( 7 )$$

where nᵢ represents the number of containers that consume GPU resources at the i^{th} node, podⱼ.gpu_memory represents the GPU memory occupied by a j^{th} container, and Σpod. gpu_memory represents the total GPU memory consumed by the container to be scheduled.

The formulas (6) and (7) show that the entropy of the cluster with fully balanced resource utilization is 1.

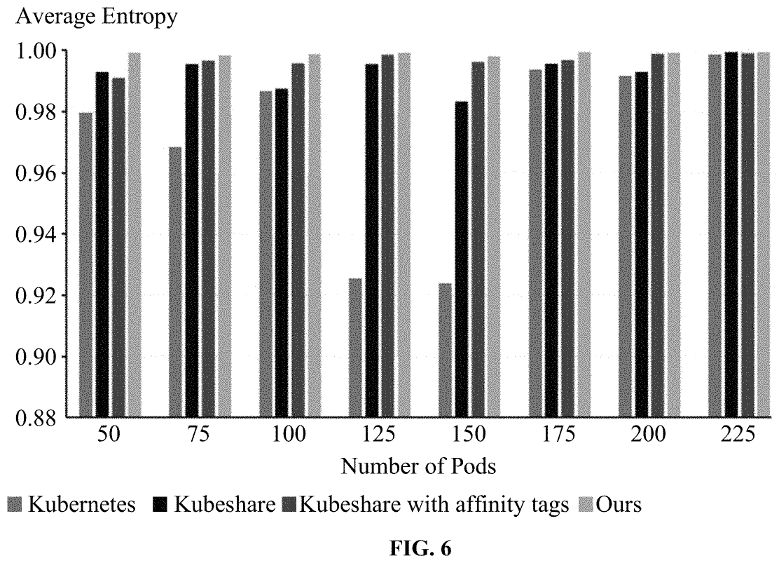

In the experiment 1, there are 225 scheduled containers each requesting the GPU memory of 2,000 M and form a scheduling queue together with Poisson distribution requests. The Kubernetes scheduler, the Kubeshare and the disclosure are respectively adopted to schedule containers and calculate the corresponding load balance entropy thereof. The results are shown in FIG. 6, in which the abscissa represents the number of scheduled containers, and the ordinate represents the average load balance entropy of the cluster. As can be seen from FIG. 6, the entropy obtained in the disclosure is closest to 1, so the scheduling performance of the disclosure is superior to that of the Kubernetes scheduler. Although the Kubernetes scheduler comprises scheduling policies such as LeastRequestedPriority and BalancedResourceAllocation to avoid excessive resource consumption at a single node, it is still in a weak balance in terms of resource utilization since the actual GPU resource consumption of the containers is not considered in the Kubernetes's default scheduling policy. Similarly, the Kubeshare adopts a Most-fit scheduling policy and a similarity marking mechanism to ensure the load balance of the cluster. However, when the container starts to consuming GPU resources, scheduling decisions are skewed. The result shows that the resource utilization of the cluster can be ensured to be more balanced in the disclosure.

Experiment 2:

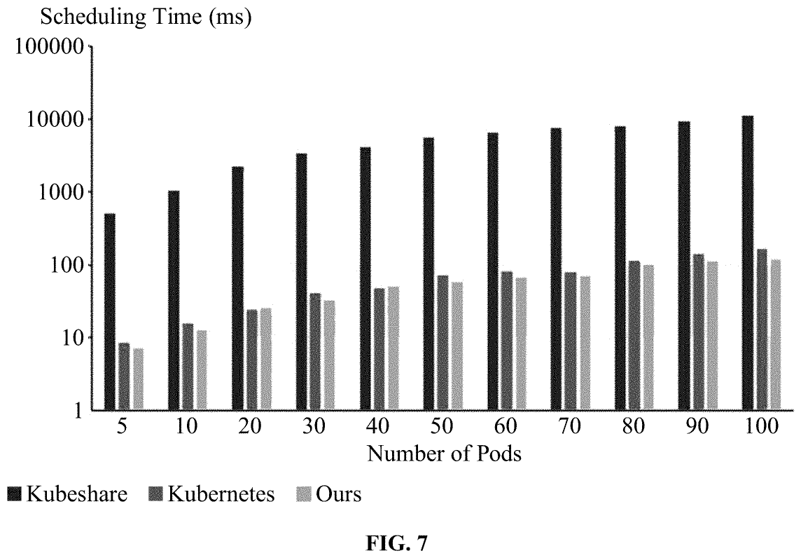

Since the current cluster needs to process large-scale concurrent tasks, the task scheduling time is an essential metric to measure the performance of the scheduler. In the experiment 2, there are 100 scheduled containers each requesting the GPU memory of 500M and form a scheduling queue together with Poisson distribution requests. The Kubernetes scheduler, the Kubeshare and the disclosure are respectively adopted to schedule containers and calculate the corresponding scheduling time. The results are shown in FIG. 7, in which the abscissa represents the number of containers to be scheduled, and the ordinate represents the scheduling time from the creation of a scheduling event to the completion of node binding of the containers. As can be seen from FIG. 7, the Kubeshare underperforms the Kubernetes scheduler and the disclosure, and is very time-consuming in affinity operations due to its consideration of affinity at the GPU level. Meanwhile, although the Kubernetes scheduler outperforms the disclosure, scheduling policies thereof lack in-depth consideration of cluster resource utilization and are relatively weak in the balance of resource utilization. Therefore, the default Kubernetes scheduler makes fast scheduling decisions but ignores scheduling quality.

In summary, the disclosure outperforms other reference methods in terms of the container scheduling time and ensures that GPU resources in the cluster are consumed in a more balanced manner.

It will be obvious to those skilled in the art that changes and modifications may be made, and therefore, the aim in the appended claims is to cover all such changes and modifications.

What is claimed is:

1. A method, comprising:
monitoring a container creation event in a Kubernetes API-Server in real time, and validating a container created once a new container creation event is detected;
updating a container scheduling queue with containers passing the validation;
when the container scheduling queue is empty, performing no operation until the containers passing the validation are added to the queue; when the container scheduling queue is not empty, reading the containers to be scheduled from the container scheduling queue in sequence, and selecting, from a Kubernetes cluster, an optimal node corresponding to the containers to be scheduled to generate a container scheduling two-tuple; and
scheduling, based on the container scheduling two-tuple, the containers to be scheduled to the optimal node to finish distributed container scheduling operation.

2. The method of claim 1, wherein validating the container created comprise:
validating GPU tags based on field information of the container created:
determining whether the container created carries the GPU tags or not; if not, indicating that a GPU tag validation fails, writing a validation failure time and corresponding error information into a Kubernetes event log; and if so, indicating that the GPU tag validation is passed, wherein the GPU tags comprise a GPU quantity tag, a GPU memory tag and a GPU clock frequency tag; and
validating a scheduler name based on the field information of the container created when the GPU tag validation is passed: determining whether a scheduler field of the container is the scheduler name of a system or not; if not, indicating that a validation of the scheduler name fails, writing a validation failure time and corresponding error information into the Kubernetes event log; and if so, indicating that the validation of the scheduler name is passed and the container validation is finished.

3. The method of claim 1, wherein updating a container scheduling queue with containers passing the validation comprise:
sending the containers passing the validation to the container scheduling queue from a rear of the queue; and
acquiring a default priority tag of each container in the container scheduling queue, and sorting all the containers in the container scheduling queue in a descending order based on priority tags to finish updating the container scheduling queue.

4. The method of claim 2, wherein selecting an optimal node corresponding to the containers to be scheduled from a Kubernetes cluster comprise:
selecting and filtering nodes in the Kubernetes cluster based on GPU data of each node and the GPU tags of the containers to be scheduled to obtain container schedulable nodes;
when there is one container schedulable node, taking this container schedulable node as the optimal node; and
when there is more than one container schedulable node, calculating a score of each container schedulable node based on the GPU data of the container schedulable node, and selecting the container schedulable node with a highest score as the optimal node.

5. The method of claim 4, wherein the container schedulable nodes are acquired by following operations:
traversing all nodes in the Kubernetes cluster when the container to be scheduled carries a GPU quantity tag, marking a node as a primary schedulable node when a number of GPUs at the node is greater than or equal to a value of the GPU quantity tag, marking all the nodes in the Kubernetes cluster as primary schedulable nodes when the container to be scheduled does not carry the GPU quantity tag, and setting the value of the GPU quantity tag of the container to be scheduled to 1;
traversing all the primary schedulable nodes when the container to be scheduled carries a GPU memory tag; taking the GPUs at the primary schedulable nodes as the GPUs meeting first level requirements when free memory of the GPUs is greater than a value of the GPU memory tag of the container to be scheduled; marking the primary schedulable nodes as secondary schedulable nodes when a number of GPUs meeting the first level requirements is greater than or equal to the value of the GPU quantity tag of the container to be scheduled, and marking all the primary schedulable nodes as secondary schedulable nodes when the container to be scheduled does not carry the GPU memory tag;
traversing all the secondary schedulable nodes when the container to be scheduled carries a GPU clock frequency tag; taking the GPUs at the secondary schedulable nodes as the GPUs meeting second level requirements when the clock frequency of the GPUs is greater than the value of the GPU clock frequency tag; marking the secondary schedulable nodes as the container schedulable nodes when a number of GPUs meeting the second level requirements is greater than or equal to the value of the GPU quantity tag of the container to be scheduled; and marking all the secondary schedulable nodes as the container schedulable nodes when the container to be scheduled does not carry the GPU clock frequency tag; and
writing a current time and scheduling error information into the Kubernetes event log when the container schedulable node is null.

6. The method of claim 4, wherein a calculation formula of the score of each container schedulable node based on the GPU data of the container schedulable node is as follows:
Score=FilteredGPUScore×FilteredGPUWeight+RealScore×RealWeight+AllocateScore×AllocateWeight (1)
where Scorere presents the score of the container schedulable node, FilteredGPUScore represents a GPU score of all the GPUs meeting the requirements of the container to be scheduled at a specific container schedulable node, and the requirements of the container to be scheduled are the GPU memory tag and the GPU clock frequency tag of the container to be scheduled, FilteredGPUWeight is a weight of the GPU score, RealScore represents a memory score of all the GPUs at the specific container schedulable node, RealWeight is a weight of the memory score, AllocateScore represents an allocated score of the container schedulable node, and AllocateWeight is a weight of the allocated score;
calculation formulas of FilteredGPUScore are as follows:
$$FilteredGPUScore = \sum FilteredGPUScorePerCard \qquad ( 2 )$$
$$FilteredGPUScorePerCard = \frac{Bandwith}{MaxBandwith} \times 100 + \frac{Clock}{MaxClock} \times 100 + \frac{Power}{MaxPower} \times 100 + \frac{Core}{MaxCore} \times 100 + \frac{FreeMemory}{MaxFreeMemory} \times 100 + \frac{TotalMemory}{MaxTotalMemory} \times 100 \qquad ( 3 )$$
where FilteredGPUScorePerCard represents a GPU score of the GPUs meeting the requirements of the container to be scheduled at the specific container schedulable node, Bandwith represents a bit bandwidth of the GPU memory, MaxBandwith represents a maximum bit bandwidth of the GPU memory of all the GPUs meeting the requirements of the container to be scheduled at the specific container schedulable node, Clock represents a GPU clock frequency, MaxClock represents a maximum GPU clock frequency of all the GPUs meeting the requirements of the container to be scheduled at the specific container schedulable node, Power represents a GPU power, MaxPower represents a maximum GPU power of all the GPUs meeting the requirements of the container to be scheduled at the specific container schedulable node, Core represents a number of GPU cores, MaxCore represents a maximum number of GPU cores of all the GPUs meeting the requirements of the container to be scheduled at the specific container schedulable node, FreeMemory represents a CPU free memory; MaxFreeMemory represents a maximum GPU free memory of all the GPUs meeting the requirements of the container to be scheduled at the specific container schedulable node, TotalMemory represents a total GPU memory, and MaxTotalMemory represents a maximum total GPU memory of all the GPUs meeting the requirements of the container to be scheduled at the specific container schedulable node;
a calculation formula of RealScore is as follows:
$$RealScore = \frac{FreeMemorySum \times 100}{TotalMemorySum} \qquad ( 4 )$$
where FreeMemorySum represents a sum of GPU free memory of all the GPUs at the specific container schedulable node, andTotalMemorySum represents a sum of the total GPU memory of all the GPUs at the specific container schedulable node;
a calculation formula of AllocateScore is as follows:
$$AllocateScore = \frac{( TotalMemorySum - AllocateMemorySum ) \times 100}{TotalMemorySum} \qquad ( 5 )$$
where AllocateMemorySum represents a total memory requested by the container to be scheduled, which is a product of the value of the GPU memory tag and the value of the GPU quantity tag value of the container to be scheduled.

7. The method of claim 1, wherein the container scheduling two-tuple comprises the containers to be scheduled and a node name of the optimal node.

8. The method of claim 7, wherein the containers to be scheduled are scheduled to the optimal node based on the container scheduling two-tuple by following operations: configuring, based on the container scheduling two-tuple, a node name field of the containers to be scheduled as the node name of the optimal node in the two-tuple, and updating the node name field of the containers in the Kubernetes API-Server asynchronously.

9. A distributed container scheduling system, the system comprising:
a container creation event monitor configured to monitor a container creation event in a Kubernetes API-Server, and validate containers once a new container creation event is detected;
a container scheduling queue configured to store containers to be scheduled based on priorities;
a container scheduler configured to read containers to be scheduled from a front of the container scheduling queue, and select, from a Kubernetes cluster, an optimal node corresponding to the containers to be scheduled to generate a container scheduling two-tuple;
a container scheduling executor configured to update, based on the container scheduling two-tuple, a node name field of the containers to be scheduled in the Kubernetes API-Server to finish the container scheduling operation; and
a communication module configured to enable the container creation event monitor, the container scheduling queue, the container scheduler and the container scheduling executor to establish communications with the Kubernetes API-Server respectively based on system config files.

10. The system of claim 9, wherein:
each system config file comprises an IP address, a port number, a transport layer security (TLS) public key and a TLS private key of the Kubernetes API-Server;
the communication is established based on the system config files by following operations:
establishing communication links between the container creation event monitor, the container scheduling queue, the container scheduler, the container scheduling executor and the Kubernetes API-Server based on the IP address and the port number; and
authenticating the communication links according to the TLS public key and the TLS private key, and finishing the communication establishment after authentication is passed.
